(19) United States
(12) Patent Application Publication
(10) Pub. No.: US 2024/0411318 A1
(43) Pub. Date: Dec. 12, 2024

(54) SWIMMING POOL MAP BOUNDARY CONSTRUCTION AND SWIMMING POOL CLEANING METHODS AND APPARATUS, AND ELECTRONIC DEVICE

(71) Applicant: Suzhou Smorobot Technology Co., Ltd., Suzhou City (CN)

(72) Inventor: Zhongchao DING, Beijing (CN)

(73) Assignee: Suzhou Smorobot Technology Co., Ltd., Suzhou City (CN)

(21) Appl. No.: 18/807,913

(22) Filed: Aug. 16, 2024

Related U.S. Application Data
(63) Continuation of application No. PCT/CN2022/076909, filed on Feb. 18, 2022.

(51) Int. Cl. G05D 1/246; E04H 4/16; G05D 1/648; G05D 105/10; G05D 107/00; G05D 109/30

(52) U.S. Cl. CPC G05D 1/246; E04H 4/1654; G05D 1/6484; G05D 2105/10; G05D 2107/29; G05D 2109/38

(57) ABSTRACT

A swimming pool map boundary construction and swimming pool cleaning methods, an apparatus, and an electronic device are provided. A swimming pool cleaning robot is controlled to move forward and backward relative to each preset path in a swimming pool map that covers a swimming pool within a working area defined by the swimming pool, to determine two path endpoints of each preset path, and map boundaries of the swimming pool map are constructed based on the determined two path endpoints of each preset path in the swimming pool map, so that the construction of swimming pool map boundaries is more efficient, reasonable and accurate. Moreover, the swimming pool cleaning task performed based on the swimming pool map constructed by the above method can achieve comprehensive cleaning of the swimming pool and avoid omissions.

### CROSS-REFERENCE TO RELATED APPLICATION

This application is a continuation of International Application No. PCT/CN2022/076909 filed on Feb. 18, 2022, and entitled “Swimming pool map boundary construction and swimming pool cleaning methods and apparatuses, and electronic device,” the contents of which is hereby incorporated by reference in its entirety.

### TECHNICAL FIELD

Embodiments of this disclosure relate to the technical field of swimming pool cleaning robot control, and in particular, to swimming pool map boundary construction and swimming pool cleaning methods and apparatus, an electronic device, and a storage medium.

### BACKGROUND

A swimming pool cleaning robot is a cleaning robot produced for a swimming pool cleaning need, which can perform a swimming pool map boundary construction task and perform a swimming pool cleaning task based on a constructed swimming pool map.

When the existing swimming pool cleaning robot performs the swimming pool map boundary construction task, the method for swimming pool map boundary construction is not efficient or reasonable, which leads to the problem of inaccurate boundaries of the constructed swimming pool map and causes adverse effects on the swimming pool cleaning task performed based on the constructed swimming pool map.

Therefore, a swimming pool map boundary construction method is desirable, which enables the swimming pool map boundary construction more efficient, reasonable and accurate, so as to complete the swimming pool cleaning task more comprehensively.

### SUMMARY

To resolve the foregoing problems, embodiments of this disclosure provide a swimming pool map boundary construction method (i.e., a method for establishing the boundary of a swimming pool map), including: controlling a swimming pool cleaning robot to move forward and backward relative to each preset path in a swimming pool map that covers a swimming pool, within a working area defined by the swimming pool, to determine two path endpoints of each preset path; and constructing map boundaries of the swimming pool map based on the determined two path endpoints of each preset path in the swimming pool map.

In one or more embodiments of the present disclosure, the swimming pool map is generated by: generating, based on an initial position and an initial orientation of the swimming pool cleaning robot, the swimming pool map that covers the working area of the swimming pool, where each preset path in the swimming pool map is parallel to the initial orientation of the swimming pool cleaning robot.

In one or more embodiments of the present disclosure, the initial position and the initial orientation of the swimming pool cleaning robot may be determined by: determining the initial position and the initial orientation of the swimming pool cleaning robot based on a position and an orientation of the swimming pool cleaning robot at a bottom of the swimming pool after freely sinking to the bottom of the swimming pool; or, controlling the swimming pool cleaning robot to move relative to the bottom of the swimming pool to a designated position and a designated orientation according to a movement instruction, and determining the designated position and the designated orientation as the initial position and initial orientation of the swimming pool cleaning robot.

In one or more embodiments of the present disclosure, controlling a swimming pool cleaning robot to move forward and backward along each preset path in a swimming pool map within a working area defined by the swimming pool, to determine two path endpoints of each preset path includes: determining a preset path where the swimming pool cleaning robot is currently located in the swimming pool map as the current path; controlling the swimming pool cleaning robot to move backward and forward relative to the current path based on a preset orientation parallel to the current path within the working area defined by the swimming pool until the swimming pool cleaning robot collides with the side walls of the swimming pool at two opposite ends of the current path respectively, to determine two path endpoints of the current path; controlling the swimming pool cleaning robot, according to a preset movement algorithm, to move from the current path to a preset path which is adjacent to the current path and of which two path endpoints have not been determined; and returning to and continuing with the step of determining the preset path where the swimming pool cleaning robot is currently located in the swimming pool map as the current path until two path endpoints of each preset path in the swimming pool map are determined.

In one or more embodiments of the present disclosure, controlling the swimming pool cleaning robot to move backward and forward relative to the current path based on the preset orientation parallel to the current path within the working area defined by the swimming pool until the swimming pool cleaning robot collides with the side walls of the swimming pool at the two opposite ends of the current path respectively, to determine the two path endpoints of the current path includes: controlling the swimming pool cleaning robot to move backward relative to the current path based on the preset orientation until the swimming pool cleaning robot collides with the side wall of the swimming pool at a first end of the current path, and determining a first path endpoint of the current path based on the current position of the swimming pool cleaning robot relative to the current path; and controlling the swimming pool cleaning robot to move forward relative to the current path based on the preset orientation until the swimming pool cleaning robot collides with the side wall of the swimming pool at a second end of the current path, and determining a second path endpoint of the current path based on the current position of the swimming pool cleaning robot relative to the current path.

In one or more embodiments of the present disclosure, controlling the swimming pool cleaning robot, according to a preset movement algorithm, to move from the current path to a preset path which is adjacent to the current path and of which two path endpoints have not been determined includes: determining, based on the current path, a preset path of which two path endpoints have not been determined and which is adjacent to the current path in the swimming pool map as a target path; and controlling the swimming pool cleaning robot to perform a U-turn according to the preset movement algorithm, so that the swimming pool cleaning robot moves from the current path to the target path, and the U-turn orientation of the swimming pool cleaning robot after completion of the U-turn is opposite to the preset orientation.

In one or more embodiments of the present disclosure, returning to and continuing with the step of determining the preset path where the swimming pool cleaning robot is currently located in the swimming pool map as the current path includes: updating the U-turn orientation of the swimming pool cleaning robot after completion of the U-turn as the preset orientation, and returning to and continuing with the step of determining the preset path where the swimming pool cleaning robot is currently located in the swimming pool map as the current path.

In one or more embodiments of the present disclosure, controlling the swimming pool cleaning robot to perform a U-turn according to the preset movement algorithm includes: controlling the swimming pool cleaning robot to perform the U-turn based on a right-angle turning mode or an arc turning mode, so that the U-turn orientation of the swimming pool cleaning robot after completion of the U-turn is opposite to the preset orientation.

In one or more embodiments of the present disclosure, the method further includes: determining each preset path of which two path endpoints have not been determined in the swimming pool map as a candidate path when there is no preset path of which two path endpoints have not been determined and which is adjacent to the current path in the swimming pool map; determining the candidate path having the shortest moving distance from the current path as a target path based on the current path and each candidate path and according to a preset path finding algorithm; and controlling the swimming pool cleaning robot to move from the current path to the target path according to the preset path finding algorithm, and returning to and continuing with the step of determining the preset path where the swimming pool cleaning robot is currently located in the swimming pool map as the current path.

In one or more embodiments of the present disclosure, each preset path in the swimming pool map includes at least one grid zone; the method further includes: for each preset path in the swimming pool map, based on the two path endpoints of the preset path, determining each grid zone in the preset path between the two path endpoints as a cleaning zone.

According to another aspect of this disclosure, a swimming pool cleaning method is provided, including: controlling a swimming pool cleaning robot to traverse each cleaning path based on two path endpoints of each cleaning path in a cleaning map corresponding to a swimming pool, to clean the swimming pool, where the two path endpoints of each cleaning path in the cleaning map are determined using the swimming pool map boundary construction method in the above aspect.

According to another aspect of this disclosure, a swimming pool map boundary construction apparatus is provided, including: an endpoint determination module, configured to control a swimming pool cleaning robot to move forward and backward relative to each preset path in a swimming pool map that covers a swimming pool within a working area defined by the swimming pool, to determine two path endpoints of each preset path; and a boundary construction module, configured to construct map boundaries of the swimming pool map based on the determined two path endpoints of each preset path in the swimming pool map.

According to another aspect of this disclosure, a swimming pool cleaning apparatus is provided, which is configured to control a swimming pool cleaning robot to traverse each cleaning path in a cleaning map corresponding to a swimming pool based on two path endpoints of each cleaning path, to clean the swimming pool, where the two path endpoints of each cleaning path in the cleaning map are determined using the above-mentioned swimming pool map boundary construction apparatus.

According to another aspect of this disclosure, an electronic device is provided, including: a processor; and a memory storing a program, where the program includes instructions that, when executed by the processor, cause the processor to perform the methods of the above aspects.

According to another aspect of this disclosure, a non-transitory computer-readable storage medium storing computer instructions is provided, where the computer instructions are used to cause a computer to perform the methods of the above aspects.

According to the swimming pool map boundary construction method and apparatus, electronic device and swimming pool cleaning method provided by this disclosure, a swimming pool cleaning robot is controlled to move forward and backward relative to each preset path in a swimming pool map that covers a swimming pool within a working area defined by the swimming pool, to determine two path endpoints of each preset path, and map boundaries of the swimming pool map are constructed based on the determined two path endpoints of each preset path in the swimming pool map, so that the construction of swimming pool map boundaries is more efficient, reasonable and accurate.

Moreover, the swimming pool cleaning task performed based on the swimming pool map constructed by the above method in this disclosure can realize comprehensive cleaning of the swimming pool and avoid omissions.

### BRIEF DESCRIPTION OF DRAWINGS

The following drawings are intended only to schematically illustrate and explain this disclosure and are not intended to limit the scope of this disclosure.

FIG. 1 is a schematic flowchart of a swimming pool map boundary construction method according to an exemplary embodiment of this disclosure;

FIG. 2 is a schematic flowchart of a swimming pool map boundary construction method according to another exemplary embodiment of this disclosure;

FIG. 3 is a schematic flowchart of a swimming pool map boundary construction method according to another exemplary embodiment of this disclosure;

FIG. 4 is a schematic flowchart of a swimming pool map boundary construction method according to another exemplary embodiment of this disclosure;

FIG. 5 is a schematic flowchart of a swimming pool map boundary construction method according to another exemplary embodiment of this disclosure;

FIG. 6 is a schematic flowchart of a swimming pool cleaning method according to an exemplary embodiment of this disclosure;

FIG. 7 is a structural block diagram of a swimming pool map boundary construction apparatus according to an exemplary embodiment of this disclosure;

FIG. 8 is a structural block diagram of an electronic device according to an exemplary embodiment of this disclosure; and

FIGS. 9A to 9G are schematic diagrams of scenario applications of the swimming pool map boundary construction method according to exemplary embodiments of this application.

### REFERENCE NUMERALS

700. swimming pool map boundary construction apparatus; 702. endpoint determination module; 704. boundary construction module; 800. electronic device; 801. computing unit; 802. ROM; 803. RAM; 804. bus; 805. input/output interface; 806. input unit; 807. output unit; 808. storage unit; 809. communication unit.

### DESCRIPTION OF EMBODIMENTS

To have a clearer understanding of the technical features, objectives, and effects of the embodiments of this disclosure, embodiments of this disclosure will be described with reference to the drawings.

In this specification, “schematic” means “as an instance, example or explanation”, and any illustration or embodiment described as “schematic” herein should not be interpreted as a more preferred or advantageous technical solution.

For simplicity of the drawings, only the parts relevant to this disclosure are schematically shown in the drawings, which do not represent actual structures of products. In addition, to make the drawings simple and easy to understand, only one or more of components having the same structure or function in some drawings are schematically depicted, or only one or more of them are designated.

When the existing swimming pool cleaning robot performs a swimming pool map boundary construction task, the method for swimming pool map boundary construction is not efficient or reasonable, which leads to the problem of inaccurate boundaries of the constructed swimming pool map and causes adverse effects on the swimming pool cleaning task performed based on the constructed swimming pool map. In view of this, an embodiment this disclosure proposes a swimming pool map boundary construction method and apparatus, an electronic device, and a swimming pool cleaning method, which can solve the above various problems existing in the prior art.

Specific embodiments of this disclosure will be described in detail below with reference to the accompanying drawings.

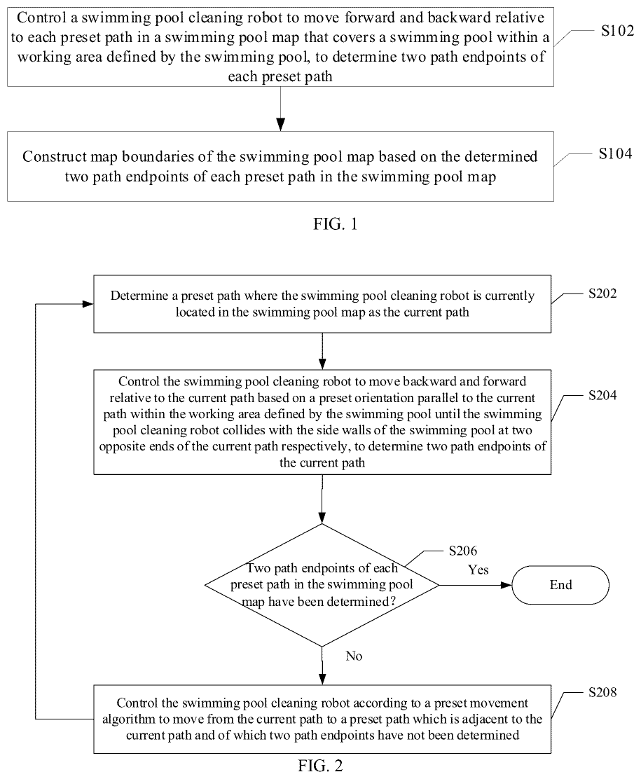

FIG. 1 is a schematic flowchart of a swimming pool map boundary construction method according to an exemplary embodiment of this disclosure. As shown in the figure, this embodiment mainly includes the following steps.

Step S102: A swimming pool cleaning robot is controlled to move forward and backward relative to each preset path in a swimming pool map that covers a swimming pool within a working area defined by the swimming pool, to determine two path endpoints of each preset path.

In one implementation, the swimming pool map may be generated by the following step: The swimming pool map that covers the working area of the swimming pool is generated based on the initial position and initial orientation of the swimming pool cleaning robot.

Each preset path in the swimming pool map is parallel to the initial orientation of the swimming pool cleaning robot.

In this embodiment, two adjacent preset paths in the swimming pool map may border each other or partially overlap each other. To efficiently construct swimming pool boundaries, the preset paths preferably border each other, and multiple rows of adjacent preset paths are generated to cover the entire swimming pool map. In addition, the width of each preset path may be determined based on the body size of the robot, so as to cover each preset path when the swimming pool cleaning robot performs a cleaning task.

In one implementation, the initial position and initial orientation of the swimming pool cleaning robot may be determined in the following way.

In one embodiment, the initial position and initial orientation of the swimming pool cleaning robot may be determined based on the position and orientation of the swimming pool cleaning robot at a bottom of the swimming pool after freely sinking to the bottom of the swimming pool. Specifically, after the swimming pool cleaning robot is put into the swimming pool, the position and orientation of the swimming pool cleaning robot at the bottom of the swimming pool after freely sinking to the bottom of the swimming pool may be determined as the initial position and initial orientation of the swimming pool cleaning robot.

In another embodiment, the swimming pool cleaning robot is also controlled to move relative to the swimming pool to a designated position and a designated orientation according to a movement instruction, and the designated position and designated orientation are determined as the initial position and initial orientation of the swimming pool cleaning robot. Specifically, after the swimming pool cleaning robot sinks to the bottom of the swimming pool, the swimming pool cleaning robot may be controlled to move relative to the bottom of the swimming pool according to the movement instruction until the expected designated position and orientation are satisfied, so as to determine the initial position and initial orientation of the swimming pool cleaning robot.

Step S104: Map boundaries of the swimming pool map are constructed based on the determined two path endpoints of each preset path in the swimming pool map.

In one implementation, the swimming pool cleaning robot may be controlled to traverse each preset path in the swimming pool map in combination with a preset movement algorithm and a preset path finding algorithm, to determine two path endpoints of each preset path, so as to construct the map boundaries of the swimming pool map.

To sum up, according to the swimming pool map boundary construction method of this embodiment, a swimming pool cleaning robot is controlled to move forward and backward relative to each preset path in a swimming pool map that covers a swimming pool within a working area defined by the swimming pool, to determine two path endpoints of each preset path, and map boundaries of the swimming pool map are constructed based on the determined two path endpoints of each preset path in the swimming pool map, so that the construction of swimming pool map boundaries is more efficient, reasonable and accurate.

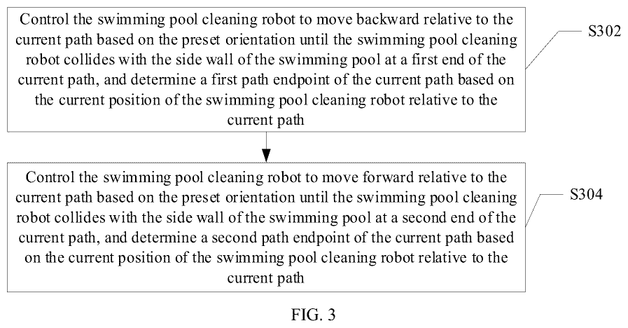

FIG. 2 is a schematic flowchart of a swimming pool map boundary construction method according to another exemplary embodiment of this disclosure. This embodiment mainly shows a specific implementation scheme of step S102 above. As shown in the figure, this embodiment mainly includes the following steps.

Step S202: A preset path where the swimming pool cleaning robot is currently located in the swimming pool map is determined as the current path.

In this embodiment, the preset path at the initial position when the swimming pool cleaning robot falls to the bottom of the swimming pool may be first determined as the current path, and the current path in the swimming pool map may be updated based on the preset path where the swimming pool cleaning robot is currently actually located in the subsequent process of constructing the map boundaries of the swimming pool map.

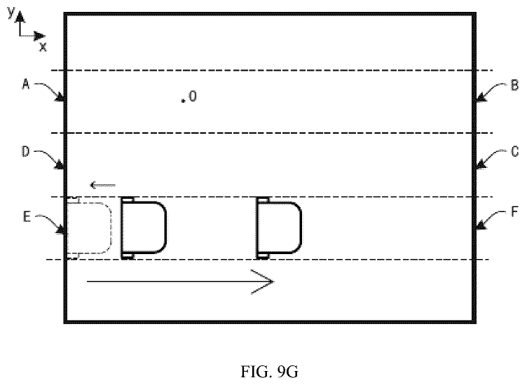

Exemplarily, with reference to the swimming pool map shown in FIG. 9A, assuming that the initial position when the swimming pool cleaning robot falls to the bottom of the swimming pool is 0, the preset path at the initial position 0 of the swimming pool cleaning robot is determined as the current path.

Step S204: The swimming pool cleaning robot is controlled to move backward and forward relative to the current path based on a preset orientation parallel to the current path within the working area defined by the swimming pool until the swimming pool cleaning robot collides with the side walls of the swimming pool at two opposite ends of the current path respectively, to determine two path endpoints of the current path.

For example, assuming that the preset path at the initial position 0 of the swimming pool cleaning robot has been determined as the current path, the preset orientation of the swimming pool cleaning robot at this time is the positive direction of the X axis. The swimming pool cleaning robot can move backward and forward along the current path. During the movement, the swimming pool cleaning robot will collide with the side walls of the swimming pool at points A and B respectively, and the points A and B are respectively determined as the two endpoints of the current path accordingly.

Step S206: Whether the two path endpoints of each preset path in the swimming pool map have been determined is determined.

Step S208: If the two path endpoints of each preset path in the swimming pool map have been determined, the process ends; if the two path endpoints of each preset path in the swimming pool map have not been determined, the swimming pool cleaning robot is controlled according to a preset movement algorithm to move from the current path to a preset path which is adjacent to the current path and of which two path endpoints have not been determined.

Specifically, if the two path endpoints of the preset paths in the swimming pool map have been determined, the construction task of the swimming pool map boundaries is completed, and the process ends; if there are still undetermined path endpoints, the swimming pool cleaning robot is controlled to move from the current path to a preset path which is adjacent to the current path and of which two path endpoints have not been determined, and step 202 is continued until the two path endpoints of the preset paths in the swimming pool map have been determined.

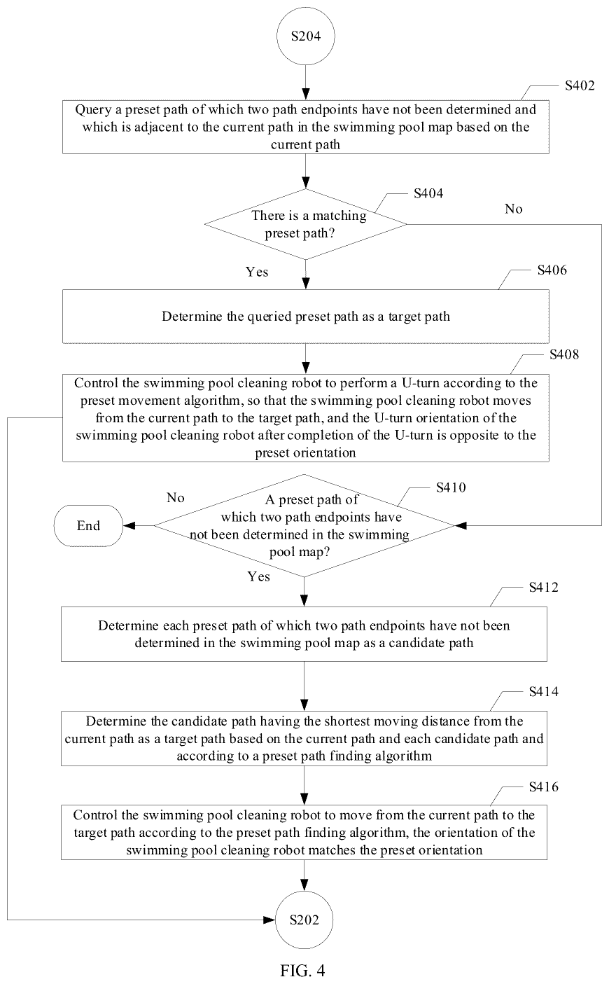

FIG. 3 shows a schematic flowchart of a swimming pool map boundary construction method according to another exemplary embodiment of this disclosure. This embodiment is a specific implementation scheme of step S204 above. As shown in the figure, this embodiment mainly includes the following steps.

Step S302: The swimming pool cleaning robot is controlled to move backward relative to the current path based on the preset orientation until the swimming pool cleaning robot collides with the side wall of the swimming pool at a first end of the current path, and a first path endpoint of the current path is determined based on the current position of the swimming pool cleaning robot relative to the current path.

Step S304: The swimming pool cleaning robot is controlled to move forward relative to the current path based on the preset orientation until the swimming pool cleaning robot collides with the side wall of the swimming pool at a second end of the current path, and a second path endpoint of the current path is determined based on the current position of the swimming pool cleaning robot relative to the current path.

Exemplarily, with reference to the swimming pool map shown in FIG. 9A, assuming that the swimming pool cleaning robot is currently located at 0 in a preset path of the swimming pool map (that is, the initial position when the swimming pool cleaning robot falls to the bottom of the swimming pool), the preset path at the initial position 0 of the swimming pool cleaning robot is determined as the current path. At this time, the preset orientation of the swimming pool cleaning robot is the positive direction of the X axis.

Based on the above determined preset orientation of the swimming pool cleaning robot and current path, the process of determining the two path endpoints of the current path is as follows:

With reference to FIG. 9A, the swimming pool cleaning robot can be controlled to move backward (i.e., the negative direction of the X axis) relative to the current path based on the positive direction of the X axis until the swimming pool cleaning robot collides with the side wall A of the swimming pool at the first end of the current path, and the first path endpoint A of the current path can be determined based on the position of the swimming pool cleaning robot relative to the current path.

With reference to FIG. 9B, the swimming pool cleaning robot is then controlled to move forward (i.e., the positive direction of the X axis) relative to the current path based on the positive direction of the X axis until the swimming pool cleaning robot collides with the side wall B of the swimming pool at the second end of the current path, and the second path endpoint B of the current path can be determined based on the current position of the swimming pool cleaning robot relative to the current path.

According to the method of this embodiment, the two path endpoints of the current path can be quickly and accurately determined, and the accuracy of construction results of swimming pool map boundaries can be improved.

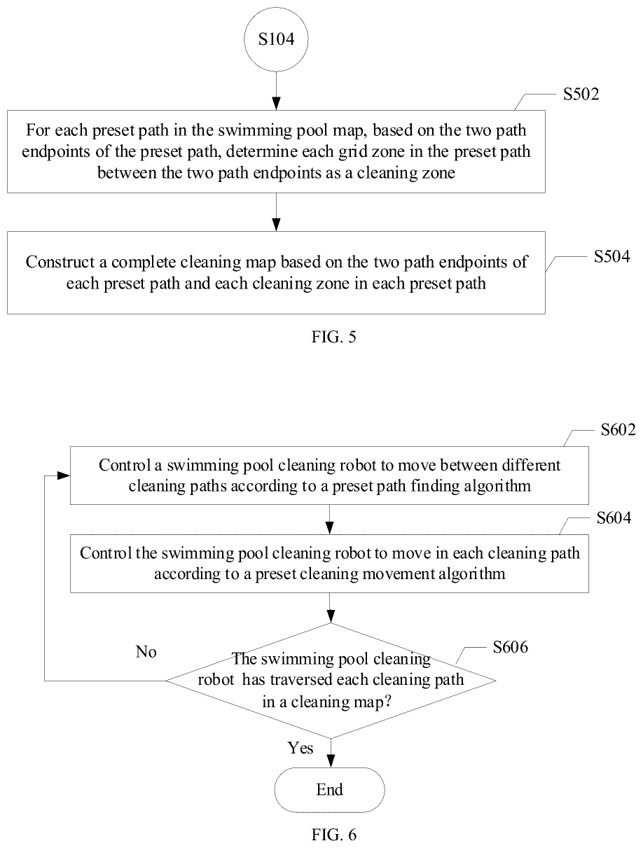

FIG. 4 shows a schematic flowchart of a swimming pool map boundary construction method according to another exemplary embodiment of this disclosure. This embodiment is a specific implementation scheme of step S208 above. As shown in the figure, this embodiment mainly includes the following steps.

Step S402: A preset path of which two path endpoints have not been determined and which is adjacent to the current path in the swimming pool map is queried based on the current path.

Specifically, when the swimming pool cleaning robot has completed the determination of the path endpoints of the current path, preset path adjacent to the current path in the swimming pool map and the determination of path endpoints of the preset paths need to be queried.

Step S404: Whether there is a matching preset path is determined, and if there is, step S406 is performed, or if there is no, step S410 is performed.

Specifically, it is determined whether there is a preset path of which path endpoints have not been determined among the preset paths adjacent to the current path in the swimming pool map.

Step S406: The queried preset path is determined as a target path.

Specifically, if there is a preset path of which two path endpoints have not been determined and which is adjacent to the current path, the preset path is taken as the target path.

Step S408: The swimming pool cleaning robot is controlled to perform a U-turn according to the preset movement algorithm, so that the swimming pool cleaning robot moves from the current path to the target path, and the U-turn orientation of the swimming pool cleaning robot after completion of the U-turn is opposite to the preset orientation. Step S202 is continued after completion of the U-turn.

In one implementation, the swimming pool cleaning robot is controlled to perform the U-turn based on a right-angle turning mode or an arc turning mode, so that the U-turn orientation of the swimming pool cleaning robot after completion of the U-turn is opposite to the preset orientation.

Specifically, the right-angle turning mode may be that, when colliding with the side wall of the swimming pool at one end of the current path, the swimming pool cleaning robot turns 90 degrees clockwise for successive two times, or turns 90 degrees counterclockwise for successive two times, to complete a 180-degree U-turn, and the U-turn orientation after completion of the U-turn is opposite to the preset orientation.

For example, with reference to FIG. 9C, after determining the second endpoint B of the current path (the preset orientation is the positive direction of the X axis), the swimming pool cleaning robot determines that the two path endpoints of the adjacent preset path (for example, CD path) have not been determined, the preset path is taken as the target path.

Specifically, if the swimming pool cleaning robot performs the U-turn by the right-angle turning mode, the swimming pool cleaning robot can be controlled to turn 90° clockwise at point B so that its orientation is opposite to the CD path (for example, the negative direction of the Y axis), and the swimming pool cleaning robot is controlled to move forward, enter the CD path from the AB path, and then turns 90° clockwise so that the U-turn orientation of the swimming pool cleaning robot is opposite to the preset orientation (for example, the negative direction of the X axis), thereby completing the movement from the current path (for example, the AB path) to the target path (for example, the CD path).

Specifically, if the swimming pool cleaning robot performs the U-turn by the arc turning mode, the swimming pool cleaning robot can be controlled to perform clockwise arc turning or counterclockwise arc turning by means of differential motion (that is, the speeds of an inner wheel and an outer wheel have a speed difference when turning, and the speed of the inner wheel is less than that of the outer wheel) when colliding with the side wall of the swimming pool at one end of the current path, so as to complete the movement from the current path to the target path.

For example, with reference to FIG. 9F, after determining the second endpoint D of the current path (CD path, the preset orientation is the negative direction of the X axis), the swimming pool cleaning robot determines that the two path endpoints of the adjacent preset path (for example, EF path) have not been determined, the preset path is taken as the target path. The swimming pool cleaning robot is controlled at point D to perform counterclockwise differential motion to move towards the EF path until the U-turn orientation of the swimming pool cleaning robot is opposite to the preset orientation (for example, the positive direction of the X axis), and the swimming pool cleaning robot moves from the CD path to the EF path.

In one implementation, the U-turn orientation of the swimming pool cleaning robot after completion of the U-turn is updated as a preset orientation, and then step S202 is continued.

For example, with reference to FIG. 9C to FIG. 9E, the preset orientation of the swimming pool cleaning robot is the positive direction of the X axis. After turning around and moving to the CD path, the orientation of the swimming pool cleaning robot is the negative direction of the X axis, the direction (the negative direction of the X axis) is updated as a preset orientation, then step S202 is performed to determine a preset path (CD path) where the swimming pool cleaning robot is currently located as the current path, the swimming pool cleaning robot moves backward and forward respectively, and the two path endpoints C and D of the current path can be determined.

Step S410: Whether there are preset paths of which two path endpoints have not been determined in the swimming pool map is determined.

Specifically, if there is no preset path of which two path endpoints have not been determined and which is adjacent to the current path, that is, the endpoints of the preset paths adjacent to the current path have all been determined, then whether there are preset paths of which two path endpoints have not been determined and which are not adjacent to the current path is determined.

Step S412: If there are preset paths of which two path endpoints have not been determined in the swimming pool map, each preset path of which two path endpoints have not been determined in the swimming pool map is determined as a candidate path; or if there are no preset paths of which two path endpoints have not been determined in the swimming pool map, the process ends.

Specifically, if there is no preset path of which two path endpoints have not been determined and which is adjacent to the current path, that is, only the endpoints of the preset paths which are not adjacent to the current path remain undetermined in the swimming pool map, all the preset paths of the undetermined path endpoints in the swimming pool map are queried, and each preset path queried is determined as a candidate path; if there are no preset paths of undetermined two path endpoints in the swimming pool map, that is, the path endpoints of all the preset paths have been determined, then the process ends.

Step S414: The candidate path having the shortest moving distance from the current path is determined as a target path based on the current path and each candidate path and according to a preset path finding algorithm.

In one implementation, the preset path finding algorithm may be an A-STAR algorithm, but is not limited thereto, and other path finding algorithms may also be used, which is not limited in this disclosure.

Specifically, the candidate path having the shortest moving distance is selected as the target path based on the moving distance of the swimming pool cleaning robot from the current path to each candidate path and according to the preset path finding algorithm.

Step S416: The swimming pool cleaning robot is controlled to move from the current path to the target path according to the preset path finding algorithm, the orientation of the swimming pool cleaning robot matches the preset orientation, and step S202 is then continued.

Specifically, the swimming pool cleaning robot is controlled to move from the current path to the target path, the orientation of the swimming pool cleaning robot matches the preset orientation, step S202 is then performed to determine a preset path where the swimming pool cleaning robot is currently located as the current path, and the swimming pool cleaning robot is controlled to move backward and forward respectively, to determine two path endpoints of next preset path.

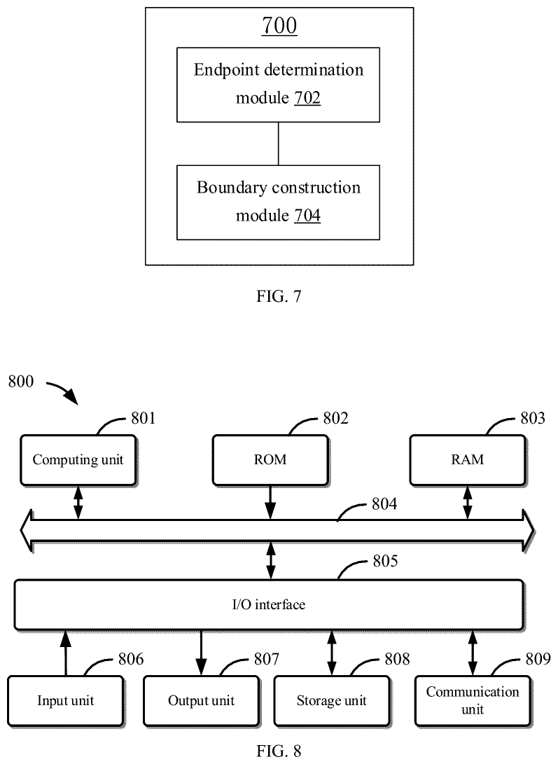

FIG. 5 shows a schematic flowchart of a swimming pool map boundary construction method according to another exemplary embodiment of this disclosure. This embodiment is a subsequent optional implementation scheme of step S104 above. As shown in the figure, this embodiment mainly includes the following steps.

Step S502: For each preset path in the swimming pool map, based on the two path endpoints of the preset path, each grid zone in the preset path between the two path endpoints is determined as a cleaning zone.

In one implementation, each preset path in the swimming pool map includes at least one grid zone.

In a specific embodiment, for each preset path in the swimming pool map, based on the two path endpoints of the preset path, each grid zone in the preset path between the two path endpoints is determined as a cleaning zone.

In this embodiment, the size of each grid zone (i.e., the length and width of the grid zone) in the preset path may be determined based on a preset stepping distance of the swimming pool cleaning robot.

In this embodiment, the preset stepping distance of the swimming pool cleaning robot may be generated based on the size of the swimming pool cleaning robot (e.g., the length and width of the swimming pool cleaning robot).

Step S504: A complete cleaning map is constructed based on the two path endpoints of each preset path and each cleaning zone in each preset path.

To sum up, a more complete cleaning map is constructed based on the two path endpoints of each preset path and each cleaning zone in each preset path, with more accurate map boundaries, so as to perform a cleaning task based on the cleaning map with better effect.

An exemplary embodiment of this disclosure further provides a swimming pool cleaning method, which can control a swimming pool cleaning robot to traverse each cleaning path based on two path endpoints of each cleaning path in a cleaning map corresponding to a swimming pool, to clean the swimming pool.

In this embodiment, the two path endpoints of each cleaning path in the cleaning map may be determined using the swimming pool map boundary construction method described in the above embodiments.

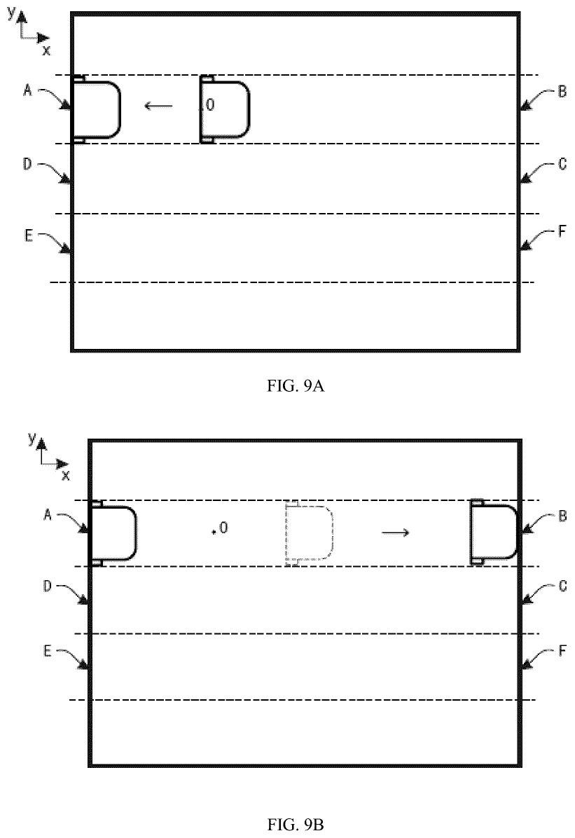

FIG. 6 is a schematic flowchart of a swimming pool cleaning method according to an exemplary embodiment of this disclosure. As shown in the figure, this embodiment specifically includes the following steps.

Step S602: A swimming pool cleaning robot is controlled to move between different cleaning paths according to a preset path finding algorithm.

In one implementation, a path endpoint having the shortest moving distance from the swimming pool cleaning robot may be determined as a target endpoint based on a path endpoint in a cleaning path where the swimming pool cleaning robot is currently located and two path endpoints of each uncleaned cleaning path in a cleaning map and according to a preset path finding algorithm, and the cleaning path including the target endpoint is determined as a cleaning path to be cleaned.

In one implementation, the preset path finding algorithm may include an A-STAR algorithm, but is not limited thereto, and other path finding algorithms may also be used, which is not limited in this disclosure.

Exemplarily, if the swimming pool cleaning robot is currently in the cleaning path corresponding to the AB path shown in FIG. 9B, a cleaning path CD that includes a path endpoint having the shortest moving distance from the swimming pool cleaning robot is found based on two path endpoints of each uncleaned cleaning path in the cleaning map and according to the preset path finding algorithm, then the path endpoint C of the cleaning path CD is determined as a target endpoint, and the cleaning path CD is determined as a cleaning path to be cleaned by the swimming pool cleaning robot.

In one implementation, the swimming pool cleaning robot may be controlled according to the preset path finding algorithm to move toward the target endpoint, so as to move from the current cleaning path to the cleaning path to be cleaned.

Specifically, the swimming pool cleaning robot may be controlled to move toward the target endpoint based on a moving path generated by the preset path finding algorithm (e.g., A-STAR algorithm), so as to move from the current cleaning path to the cleaning path to be cleaned.

Step S604: The swimming pool cleaning robot is controlled to move in each cleaning path according to a preset cleaning movement algorithm.

In one implementation, one of the two path endpoints of the current cleaning path that matches the target endpoint may be determined as a starting endpoint, the other one of the two path endpoints may be determined as a termination endpoint, and the swimming pool cleaning robot is controlled to move from the starting endpoint to the termination endpoint to traverse the current cleaning path.

For example, based on two area endpoints of the cleaning path of the EF path shown in FIG. 9G, that is, path endpoint E and path endpoint F, the path endpoint E that matches the target endpoint may be determined as a starting endpoint, and the path endpoint F may be determined as a termination endpoint, to drive the swimming pool cleaning robot to move from the path endpoint E to the path endpoint F, so as to traverse the current cleaning path EF.

Step S606: Whether the swimming pool cleaning robot has traversed each cleaning path in a cleaning map is determined. If the swimming pool cleaning robot has traversed each cleaning path, the process ends; if the swimming pool cleaning robot has not traversed each cleaning path, step S602 is continued.

It should be noted that there is no strict order of step S602 and step S604 in this embodiment, that is, step S604 may be first performed and then step S602 may be performed, and the two steps may be alternately performed until the swimming pool cleaning robot has traversed each cleaning path in the cleaning map.

For example, after each row of cleaning path in the cleaning map is generated, step S604 is first performed to determine, based on two path endpoints of a cleaning path where the swimming pool cleaning robot is currently located, one of the two path endpoints that has the shorter moving distance from the swimming pool cleaning robot as a starting endpoint, and the other one of the two path endpoints as a termination endpoint, to drive the swimming pool cleaning robot to perform a cleaning task in the current cleaning path, and after the cleaning is completed, step S602 is continued.

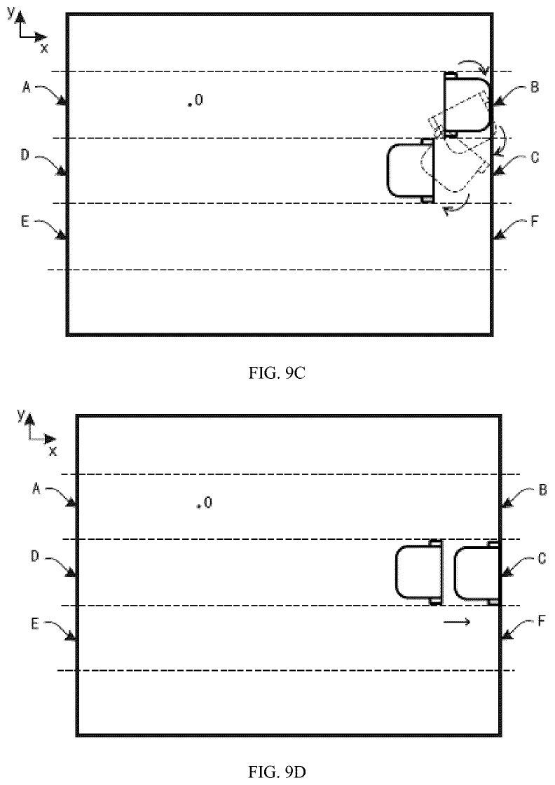

FIG. 7 shows a structural block diagram of a swimming pool map boundary construction apparatus according to an exemplary embodiment of this disclosure.

The swimming pool map boundary construction apparatus 700 in this embodiment may be installed in a swimming pool cleaning robot, which may be adapted to perform a swimming pool map boundary construction task.

As shown in the figure, the swimming pool map boundary construction apparatus 700 in this embodiment mainly includes an endpoint determination module 702 and a boundary construction module 704.

The endpoint determination module 702 is configured to control a swimming pool cleaning robot to move forward and backward relative to each preset path in a swimming pool map that covers a swimming pool within a working area defined by the swimming pool, to determine two path endpoints of each preset path.

The boundary construction module 704 is configured to construct map boundaries of the swimming pool map based on the determined two path endpoints of each preset path in the swimming pool map.

In one implementation, the swimming pool map boundary construction apparatus 700 further includes a map generating module, configured to generate, based on the initial position and initial orientation of the swimming pool cleaning robot, the swimming pool map that covers the working area of the swimming pool, where each preset path in the swimming pool map is parallel to the initial orientation of the swimming pool cleaning robot.

In one implementation, the initial position and initial orientation of the swimming pool cleaning robot may be determined by: determining the initial position and initial orientation of the swimming pool cleaning robot based on the position and orientation of the swimming pool cleaning robot at a bottom of the swimming pool after freely sinking to the bottom of the swimming pool; or, controlling the swimming pool cleaning robot to move relative to the bottom of the swimming pool to a designated position and a designated orientation according to a movement instruction, and determining the designated position and designated orientation as the initial position and initial orientation of the swimming pool cleaning robot.

In one implementation, the endpoint determination module 702 is further configured to: determine a preset path where the swimming pool cleaning robot is currently located in the swimming pool map as the current path; control the swimming pool cleaning robot to move backward and forward relative to the current path based on a preset orientation parallel to the current path within the working area defined by the swimming pool until the swimming pool cleaning robot collides with the side walls of the swimming pool at two opposite ends of the current path respectively, to determine two path endpoints of the current path; control the swimming pool cleaning robot, according to a preset movement algorithm, to move from the current path to a preset path which is adjacent to the current path and of which two path endpoints have not been determined; and return to and continuing with the step of determining a preset path where the swimming pool cleaning robot is currently located in the swimming pool map as the current path until two path endpoints of each preset path in the swimming pool map are determined.

In one implementation, the endpoint determination module 702 is further configured to: control the swimming pool cleaning robot to move backward relative to the current path based on the preset orientation until the swimming pool cleaning robot collides with the side wall of the swimming pool at a first end of the current path, and determine a first path endpoint of the current path based on the current position of the swimming pool cleaning robot relative to the current path; and control the swimming pool cleaning robot to move forward relative to the current path based on the preset orientation until the swimming pool cleaning robot collides with the side wall of the swimming pool at a second end of the current path, and determine a second path endpoint of the current path based on the current position of the swimming pool cleaning robot relative to the current path.

In one implementation, the endpoint determination module 702 is further configured to: determine, based on the current path, a preset path of which two path endpoints have not been determined and which is adjacent to the current path in the swimming pool map as a target path; and control the swimming pool cleaning robot to perform a U-turn according to the preset movement algorithm, so that the swimming pool cleaning robot moves from the current path to the target path, and the U-turn orientation of the swimming pool cleaning robot after completion of the U-turn is opposite to the preset orientation.

In one implementation, the endpoint determination module 702 is further configured to: update the U-turn orientation of the swimming pool cleaning robot after completion of the U-turn as a preset orientation, and return to and continuing with the step of determining a preset path where the swimming pool cleaning robot is currently located in the swimming pool map as the current path.

In one implementation, the endpoint determination module 702 is further configured to: control the swimming pool cleaning robot to perform the U-turn based on a right-angle turning mode or an arc turning mode, so that the U-turn orientation of the swimming pool cleaning robot after completion of the U-turn is opposite to the preset orientation.

In one implementation, the endpoint determination module 702 is further configured to: determine the candidate path having the shortest moving distance from the current path as a target path based on the current path and each candidate path and according to a preset path finding algorithm; and control the swimming pool cleaning robot to move from the current path to the target path according to the preset path finding algorithm, and return to and continuing with the step of determining a preset path where the swimming pool cleaning robot is currently located in the swimming pool map as the current path.

In one implementation, the swimming pool map boundary construction apparatus 700 may be further configured to, for each preset path in the swimming pool map, based on the two path endpoints of the preset path, determine each grid zone in the preset path between the two path endpoints as a cleaning zone.

In addition, the swimming pool map boundary construction apparatus 700 in the embodiment of this disclosure may also be configured to implement other steps in the foregoing embodiments of the swimming pool map boundary construction method, and has the beneficial effects of the corresponding method step embodiments, which will not be repeated here.

An exemplary embodiment of this disclosure further provides a swimming pool cleaning apparatus, which is installed in a swimming pool cleaning robot, where the swimming pool cleaning robot can be adapted to perform a swimming pool cleaning task.

The swimming pool cleaning apparatus in this embodiment is configured to control the swimming pool cleaning robot to traverse each cleaning path based on two path endpoints of each cleaning path in a cleaning map corresponding to a swimming pool, to clean the swimming pool, where the two path endpoints of each cleaning path in the cleaning map are determined using the swimming pool map boundary construction apparatus in the above-mentioned embodiment.

An exemplary embodiment of this disclosure further provides an electronic device, including: at least one processor; and a memory in communication connection with the at least one processor. The memory stores a computer program executable by the at least one processor, the computer program being used to cause the electronic device to perform the methods according to the embodiments of this disclosure when executed by the at least one processor.

An exemplary embodiment of this disclosure further provides a non-transitory computer-readable storage medium storing computer instructions, where the computer program, when executed by a processor of a computer, is used to cause the computer to perform the methods according to the embodiments of this disclosure.

An exemplary embodiment of this disclosure further provides a computer program product, including a computer program, where the computer program, when executed by a processor of a computer, is used to cause the computer to perform the methods according to the embodiments of this disclosure.

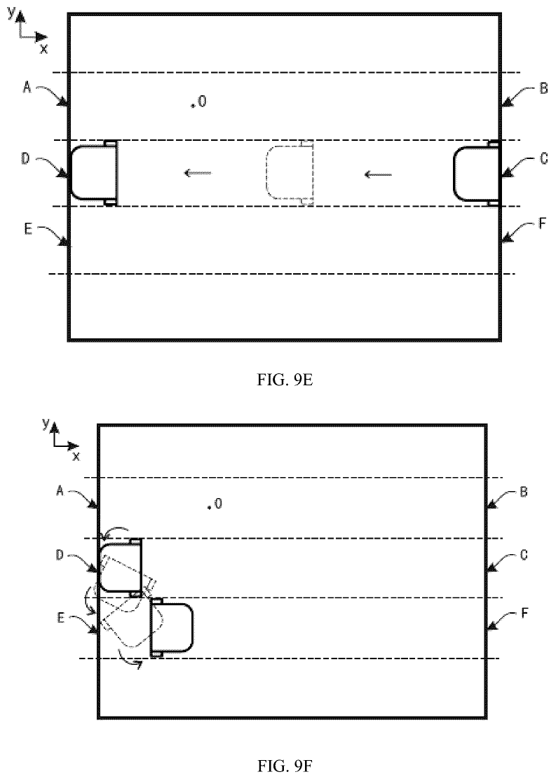

With reference to FIG. 8, a structural block diagram of an electronic device 800 that can serve as a server or a client will now be described, which is an example of a hardware device that can be applied to various aspects of this disclosure. The electronic device is intended to represent various forms of digital electronic computer devices, such as a laptop, a desktop, a worktable, a personal digital assistant, a server, a blade server, a mainframe computer, and other suitable computers. The electronic device may also represent various forms of mobile devices, such as a personal digital assistant, a cellular phone, a smart phone, a wearable device, and other similar computing devices. For components shown herein, their connections and relationships, and their functions are by way of example only, and are not intended to limit implementations of this disclosure described and/or claimed herein.

As shown in FIG. 8, the electronic device 800 includes a computing unit 801, which may perform various appropriate operations and processes based on computer programs stored in a read-only memory (ROM) 802 or computer programs loaded from a storage unit 808 to a random access memory (RAM) 803. The RAM 803 may also store various programs and data required by the operations of the device 800. The computing unit 801, the ROM 802, and the RAM 803 are connected to each other by a bus 804. An input/output (I/O) interface 805 is also connected to the bus 804.

A plurality of components in the electronic device 800 is connected to the I/O interface 805, including: an input unit 806, an output unit 807, a storage unit 808, and a communication unit 809. The input unit 806 may be any type of device capable of inputting information to the electronic device 800, and the input unit 806 may receive input numerical or character information and generate key signal input related to user settings and/or function control of the electronic device. The output unit 807 may be any type of device capable of presenting information, and may include, but is not limited to, a display, a speaker, a video/audio output terminal, a vibrator, and/or a printer. The storage unit 804 may include, but is not limited to, a magnetic disk and an optical disk. The communication unit 809 allows the electronic device 800 to exchange information/data with other devices through computer networks such as the Internet and/or various telecommunication networks, and may include, but is not limited to, a modem, a network card, an infrared communication device, a wireless communication transceiver and/or a chipset, such as a Bluetooth™ device, a WiFi device, a WiMax device, a cellular communication device and/or the like.

The computing unit 801 may be a variety of general-purpose and/or dedicated processing components with processing and computing capabilities. Some examples of the computing unit 801 include, but are not limited to, a central processing unit (CPU), a graphics processing unit (GPU), various specialized artificial intelligence (AI) computing chips, various computing units that run machine learning model algorithms, a digital signal processor (DSP), and any suitable processor, controller, microcontroller, etc. The computing unit 801 performs the various methods and processes described above. For example, in some embodiments, the swimming pool cleaning method in the foregoing embodiments may be implemented as a computer software program tangibly included in a machine-readable medium, such as the storage unit 808. In some embodiments, part or all of the computer program may be loaded and/or installed to the electronic device 800 via the ROM 802 and/or the communication unit 809. In some embodiments, the computing unit 801 may be configured to perform the swimming pool cleaning method by any other suitable means (for example, by means of firmware).

Program codes for implementing the methods of this disclosure may be written in one programming language or any combination of more programming languages. The program codes may be provided to a processor or controller of a general purpose computer, a special purpose computer or other programmable data processing apparatus, so that the program codes, when executed by the processor or controller, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or a server.

In the context of this disclosure, the machine-readable medium may be a tangible medium that may include or store programs used by an instruction execution system, apparatus or device or used with the instruction execution system, apparatus or device. The machine-readable medium may be a machine-readable signal medium or a machine-readable storage medium. The machine-readable medium may include, but is not limited to, electric, magnetic, optical, electromagnetic, infrared, or semiconductor systems, apparatuses, devices, or a combination of any of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), a fiber, a portable compact disk read-only memory (CD-ROM), an optical memory, a magnet memory, or any suitable combination of the above.

As used in this disclosure, the terms “machine-readable medium” and “computer-readable medium” refer to any computer program product, device, and/or apparatus (for example, a magnetic disk, an optical disk, a memory, and a programmable logic device (PLD)) for providing machine instructions and/or data to a programmable processor, including a machine-readable medium that receives machine instructions as machine-readable signals. The term “machine-readable signal” refers to any signal used to provide machine instructions and/or data to the programmable processor.

To provide interaction with a user, the system and technology described herein may be implemented on a computer, the computer including: a display device (for example, a CRT (cathode ray tube) or LCD (liquid crystal display) monitor) for displaying information to the user); and a keyboard and a pointing device (for example, a mouse or a trackball) through which the user can provide input to the computer. Other types of devices may also be used to provide interaction with the user, for example, the feedback provided to the user may be any form of sensory feedback (for example, visual feedback, auditory feedback, or tactile feedback); and may be in any form (including acoustic input, voice input, or tactile input) to receive input from the user.

The system and technology described herein may be implemented on a computing system including back-end components (for example, serving as a data server), or a computing system including middleware components (for example, an application server), or a computing system including front-end components (for example, a user computer having a graphical user interface or a web browser through which the user can interact with the embodiments of the system and technology described herein), or a computing system including any combination of such back-end components, middleware components, or front-end components. The components of the system may be interconnected by any form or medium of digital data communication (for example, a communication network). Examples of the communication network include: a Local Area Network (LAN), a Wide Area Network (WAN), and the Internet.

The computer system may include a client and a server. The client and the server are generally remote from each other and usually interact through a communication network. The relationship between the client and the server is generated by virtue of computer programs running on corresponding computers and having a client-server relationship to each other.

It should be understood that although this specification is described in accordance with various embodiments, each embodiment does not contain only one independent technical solution. Such a description manner of the specification is merely intended for the sake of clarity and the specification should be taken as a whole by those skilled in the art. The technical solutions in the various embodiments may be suitably combined to form other implementations that may be understood by those skilled in the art.

The foregoing descriptions are merely schematic implementations of the embodiments of this disclosure, and are not construed as a limitation on the scope of the embodiments of this disclosure. Any equivalent changes, modifications and combinations made by those skilled in the art without departing from the concepts and principles of the embodiments of this disclosure shall fall within the scope of protection of the embodiments of this disclosure.

What is claimed is:

1. A swimming pool map boundary construction method, comprising:
controlling a swimming pool cleaning robot to move forward and backward, relative to each preset path in a swimming pool map that covers a swimming pool, within a working area defined by the swimming pool, to determine two path endpoints of each preset path; and
constructing map boundaries of the swimming pool map based on the determined two path endpoints of each preset path in the swimming pool map.

2. The method according to claim 1, wherein the swimming pool map is generated by:
generating, based on an initial position and an initial orientation of the swimming pool cleaning robot, the swimming pool map that covers the working area of the swimming pool, wherein each preset path in the swimming pool map is parallel to the initial orientation of the swimming pool cleaning robot.

3. The method according to claim 2, wherein the initial position and the initial orientation of the swimming pool cleaning robot is determined by:
determining, based on a position and an orientation of the swimming pool cleaning robot at a bottom of the swimming pool when freely sinking to the bottom of the swimming pool, the initial position and initial orientation of the swimming pool cleaning robot; or
controlling the swimming pool cleaning robot to move relative to the bottom of the swimming pool to a designated position and a designated orientation according to a movement instruction, and determining the designated position and the designated orientation as the initial position and the initial orientation of the swimming pool cleaning robot.

4. The method according to claim 1, wherein the controlling the swimming pool cleaning robot to move forward and backward relative to each preset path in the swimming pool map within the working area defined by the swimming pool, to determine the two path endpoints of each preset path comprises:
determining a preset path where the swimming pool cleaning robot is currently located in the swimming pool map as the current path;
controlling the swimming pool cleaning robot to move backward and forward relative to the current path based on a preset orientation parallel to the current path within the working area defined by the swimming pool, until the swimming pool cleaning robot collides with side walls of the swimming pool at two opposite ends of the current path respectively, to determine the two path endpoints of the current path;
controlling the swimming pool cleaning robot, according to a preset movement algorithm, to move from the current path to a preset path which is adjacent to the current path and of which two path endpoints have not been determined; and
returning to and continuing with the step of determining the preset path where the swimming pool cleaning robot is currently located in the swimming pool map as the current path until the two path endpoints of each preset path in the swimming pool map are determined.

5. The method according to claim 4, wherein the controlling the swimming pool cleaning robot to move backward and forward relative to the current path based on the preset orientation parallel to the current path within the working area defined by the swimming pool until the swimming pool cleaning robot collides with the side walls of the swimming pool at the two opposite ends of the current path respectively, to determine the two path endpoints of the current path comprises:
controlling the swimming pool cleaning robot to move backward relative to the current path based on the preset orientation until the swimming pool cleaning robot collides with the side wall of the swimming pool at a first end of the current path, and determining a first path endpoint of the current path based on the current position of the swimming pool cleaning robot relative to the current path; and
controlling the swimming pool cleaning robot to move forward relative to the current path based on the preset orientation until the swimming pool cleaning robot collides with the side wall of the swimming pool at a second end of the current path, and determining a second path endpoint of the current path based on the current position of the swimming pool cleaning robot relative to the current path.

6. The method according to claim 5, wherein the controlling the swimming pool cleaning robot, according to the preset movement algorithm, to move from the current path to the preset path which is adjacent to the current path and of which two path endpoints have not been determined comprises:
determining, based on the current path, a preset path of which two path endpoints have not been determined and which is adjacent to the current path in the swimming pool map as a target path; and
controlling the swimming pool cleaning robot to perform a U-turn according to the preset movement algorithm, so that the swimming pool cleaning robot moves from the current path to the target path, wherein a U-turn orientation of the swimming pool cleaning robot after completion of the U-turn is opposite to the preset orientation.

7. The method according to claim 6, wherein the returning to and the continuing with the step of determining the preset path where the swimming pool cleaning robot is currently located in the swimming pool map as the current path comprises:
updating the U-turn orientation of the swimming pool cleaning robot after completion of the U-turn as the preset orientation; and
returning to and continuing with the step of determining the preset path where the swimming pool cleaning robot is currently located in the swimming pool map as the current path.

8. The method according to claim 6, wherein the controlling the swimming pool cleaning robot to perform the U-turn according to the preset movement algorithm comprises:
controlling the swimming pool cleaning robot to perform the U-turn based on a right-angle turning mode or an arc turning mode, so that the U-turn orientation of the swimming pool cleaning robot after completion of the U-turn is opposite to the preset orientation.

9. The method according to claim 6, wherein the method further comprises:
determining each preset path of which the two path endpoints have not been determined in the swimming pool map as a candidate path when there is no preset path of which two path endpoints have not been determined and which is adjacent to the current path in the swimming pool map;
determining the candidate path having the shortest moving distance from the current path as a target path based on the current path and each candidate path according to a preset path finding algorithm;
controlling the swimming pool cleaning robot to move from the current path to the target path according to the preset path finding algorithm; and
returning to and continuing with the step of determining the preset path where the swimming pool cleaning robot is currently located in the swimming pool map as the current path.

10. The method according to claim 1, wherein each preset path in the swimming pool map comprises at least one grid zone, the method further comprising:
for each preset path in the swimming pool map, determining each grid zone in the preset path between the two path endpoints of the preset path as a cleaning zone based on the two path endpoints.

11. A swimming pool cleaning method, comprising:
controlling, based on two path endpoints of each cleaning path in a cleaning map corresponding to a swimming pool, a swimming pool cleaning robot to traverse each cleaning path to clean the swimming pool, wherein the two path endpoints of each cleaning path in the cleaning map are determined using a swimming pool map boundary construction method, the swimming pool map boundary construction method comprising:
controlling the swimming pool cleaning robot to move forward and backward, relative to each preset path in a swimming pool map that covers the swimming pool, within a working area defined by the swimming pool, to determine two path endpoints of each preset path; and
constructing map boundaries of the swimming pool map based on the determined two path endpoints of each preset path in the swimming pool map.

12. The method according to claim 11, wherein the controlling the swimming pool cleaning robot to traverse each cleaning path based on the two path endpoints of each cleaning path in the cleaning map corresponding to the swimming pool comprises:
an inter-path moving step: controlling the swimming pool cleaning robot to move between different cleaning paths according to a preset path finding algorithm;
an intra-path moving step: controlling the swimming pool cleaning robot to move in each cleaning path according to a preset cleaning movement algorithm; and
alternately performing the inter-path moving step and intra-path moving step until the swimming pool cleaning robot traverses each cleaning path in the cleaning map.

13. The method according to claim 12, wherein the inter-path moving step comprises:
determining a path endpoint having the shortest moving distance from the swimming pool cleaning robot as a target endpoint based on a path endpoint of a current cleaning path where the swimming pool cleaning robot is currently located and two path endpoints of each uncleaned cleaning path in the cleaning map according to the preset path finding algorithm;
determining a cleaning path including the target endpoint as a cleaning path to be cleaned;
controlling the swimming pool cleaning robot to move toward the target endpoint according to the preset path finding algorithm, so as to move from a current cleaning area to the cleaning path to be cleaned; and
continuing to the intra-path moving step after the cleaning path to be cleaned is updated to the current cleaning path.

14. The method according to claim 13, wherein the intra-path moving step comprises:
determining one of the two path endpoints of the current cleaning path that matches the target endpoint as a starting endpoint;
determining the other one of the two path endpoints as a termination endpoint; and
controlling the swimming pool cleaning robot to move from the starting endpoint to the termination endpoint, so as to traverse the current cleaning path; and
continuing the inter-path moving step.

15. The method according to claim 11, wherein the method further comprises:
determining a path endpoint having the shortest moving distance from the swimming pool cleaning robot as a target endpoint based on a current cleaning path where the swimming pool cleaning robot is currently located in the cleaning map and two path endpoints of each uncleaned cleaning path in the cleaning map and according to a preset path finding algorithm;
determining a cleaning path including the target endpoint as a cleaning path to be cleaned;
controlling the swimming pool cleaning robot to move toward the target endpoint according to the preset path finding algorithm;
updating the cleaning path to be cleaned as the current cleaning path after the swimming pool cleaning robot arrives at the target endpoint; and
continuing to the intra-path moving step.

16. The method according to claim 11, further comprising:
controlling, by a swimming pool cleaning apparatus, the swimming pool cleaning robot to traverse each cleaning path to clean the swimming pool based on the two path endpoints of each cleaning path in the cleaning map corresponding to the swimming pool.

17. An electronic device, comprising:
a processor; and
a memory storing instructions that, when executed by the processor, cause the processor to perform a swimming pool cleaning method, the swimming pool cleaning method comprising:
controlling, based on two path endpoints of each cleaning path in a cleaning map corresponding to a swimming pool, a swimming pool cleaning robot to traverse each cleaning path to clean the swimming pool, wherein the two path endpoints of each cleaning path in the cleaning map are determined using a swimming pool map boundary construction method, the swimming pool map boundary construction method comprising:
controlling the swimming pool cleaning robot to move forward and backward, relative to each preset path in a swimming pool map that covers the swimming pool, within a working area defined by the swimming pool, to determine two path endpoints of each preset path; and
constructing map boundaries of the swimming pool map based on the determined two path endpoints of each preset path in the swimming pool map.

18. The electronic device according to claim 17, wherein the controlling the swimming pool cleaning robot to traverse each cleaning path based on the two path endpoints of each cleaning path in the cleaning map corresponding to the swimming pool comprises:
an inter-path moving step: controlling the swimming pool cleaning robot to move between different cleaning paths according to a preset path finding algorithm;
an intra-path moving step: controlling the swimming pool cleaning robot to move in each cleaning path according to a preset cleaning movement algorithm; and
alternately performing the inter-path moving step and intra-path moving step until the swimming pool cleaning robot traverses each cleaning path in the cleaning map.

19. The electronic device according to claim 18, wherein the inter-path moving step comprises:
determining a path endpoint having the shortest moving distance from the swimming pool cleaning robot as a target endpoint based on a path endpoint of a current cleaning path where the swimming pool cleaning robot is currently located and two path endpoints of each uncleaned cleaning path in the cleaning map according to the preset path finding algorithm;
determining a cleaning path including the target endpoint as a cleaning path to be cleaned;
controlling the swimming pool cleaning robot to move toward the target endpoint according to the preset path finding algorithm, so as to move from a current cleaning area to the cleaning path to be cleaned; and
continuing to the intra-path moving step after the cleaning path to be cleaned is updated as the current cleaning path.

20. The electronic device according to claim 19, wherein the intra-path moving step comprises:
determining one of the two path endpoints of the current cleaning path that matches the target endpoint as a starting endpoint;
determining the other one of the two path endpoints as a termination endpoint;
controlling the swimming pool cleaning robot to move from the starting endpoint to the termination endpoint, so as to traverse the current cleaning path; and
continuing the inter-path moving step.
